(19) United States
(12) Patent Application Publication
(10) Pub. No.: US 2025/0239168 A1
(43) Pub. Date: Jul. 24, 2025

(54) TRAINING SYSTEM FOR WORKPLACE SAFETY TRAINING

(71) Applicant: Tesseract Ventures, LLC, Overland Park, KS (US)

(72) Inventors: John Boucard, Kansas City, MO (US); Jason Harrell, Tampa, FL (US)

(73) Assignee: Tesseract Ventures, LLC, Overland Park, KS (US)

(21) Appl. No.: 19/020,048

(22) Filed: Jan. 14, 2025

Related U.S. Application Data
(60) Provisional application No. 63/623,548, filed on Jan. 22, 2024.

(51) Int. Cl. G09B 5/02; G06Q 10/0631; G06Q 50/20; G07C 9/00

(52) U.S. Cl. CPC G09B 5/02; G06Q 10/06311; G06Q 50/2057; G07C 9/00182; G07C 9/00571

(57) ABSTRACT

A training system provides workplace safety training. The training system includes one or more training mechanisms and a badge. The badge is operable to be registered with an employee and is operable to communicate with the training mechanisms. The training mechanisms are each operable to provide a training program to the employee. The badge is operable to receive progress of the employee for the training program from the training mechanisms, and the badge is operable to control access of the employee into an area of a jobsite based on the progress of the employee for the training program.

### CROSS-REFERENCE TO RELATED APPLICATIONS

This application claims priority to U.S. Provisional Patent Application No. 63/623,548, filed in the U.S. Patent and Trademark Office on Jan. 22, 2024, which is incorporated herein by reference in its entirety for all purposes.

### FIELD

The present disclosure relates generally to a training system operable to provide workplace safety training.

### BACKGROUND

Training for workplace safety is necessary to ensure that the jobsite is safe and to ensure that the tasks on the jobsite are properly performed. However, conventional training includes simply watching videos. There is often little interaction with the employee to ensure that the training will be correctly implemented. Also, once the videos are watched by the employee, the employee has access to the jobsite where there is no additional training available.

### BRIEF DESCRIPTION OF THE DRAWINGS

Implementations of the present technology will now be described, by way of example only, with reference to the attached figures, wherein:

FIG. 1 illustrates a training system;

FIG. 2 illustrates the training system implemented in a training environment;

FIG. 3 illustrates a badge room in the training environment;

FIG. 4 illustrates a station training room in the training environment;

FIG. 5 illustrates a kiosk training room in the training environment;

FIG. 6 illustrates a training kiosk provided on a jobsite;

FIG. 7 illustrates the training kiosk provided on the jobsite with a removable device;

FIG. 8 illustrates a VR training room in the training environment; and

FIG. 9 is a schematic diagram of a control system which may be employed as shown in FIGS. 1-8.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented. The term “coupled” is defined as connected, whether directly or indirectly through intervening components, and is not necessarily limited to physical connections. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “about” means reasonably close to the particular value. For example, about does not require the exact measurement specified and can be reasonably close. As used herein, the word “about” can include the exact number. The term “near” as used herein is within a short distance from the particular mentioned object. The term “near” can include abutting as well as relatively small distance beyond abutting. The terms “comprising,” “including” and “having” are used interchangeably in this disclosure. The terms “comprising,” “including” and “having” mean to include, but not necessarily be limited to the things so described.

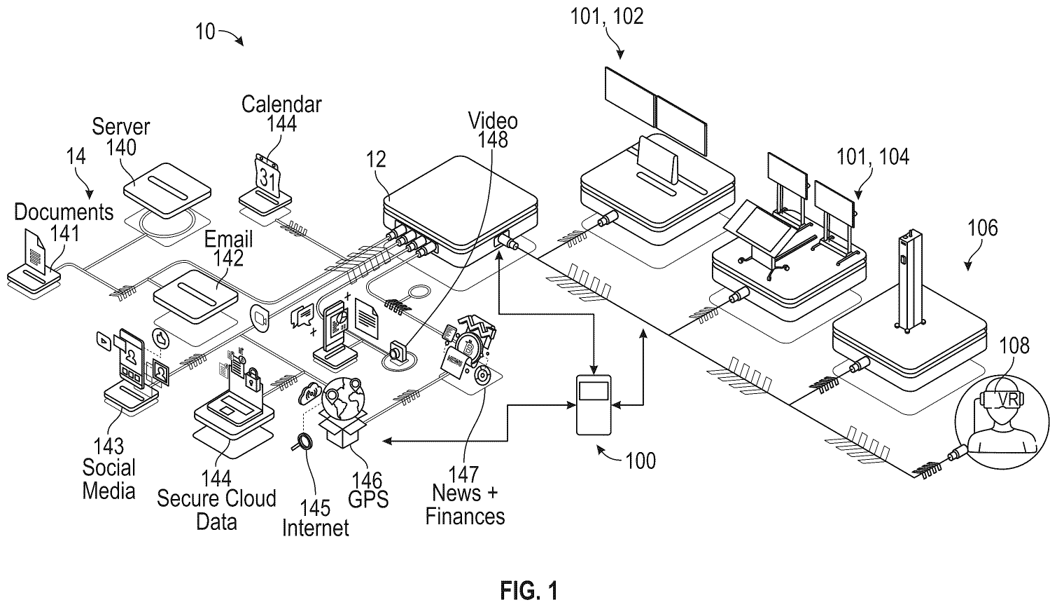

FIG. 1 illustrates an example of a training system 10 that is operable to provide workplace safety training. In some examples, the workplace safety training can include training for construction. Construction workplaces can be extremely dangerous, so training is critical to ensure that the jobsite is safe and the work is completed efficiently and effectively. In some examples, the training can be completed for other workplaces such as oil and gas, refineries, energy sites, mining, wastewater operations, or any other industry where training is needed to ensure safety and/or proper work completion.

The training system 10 includes a control system 12, a badge 100, a suite of data sources 14, and one or more training mechanisms 101, 106, 108. The one or more training mechanisms can include one or more training stations 101, one or more training kiosks 106, and/or one or more virtual reality (VR) systems 108. The control system 12 can be operable to receive data from the suite of data sources 14 and the badge 100. The control system 12 can then integrate the data into a training program that is tailored for each employee's specific needs, expertise, and experience.

For example, the suite of data sources 14 can include at least one of the following: a server 140, documents 141, email 142, social media 143, secure cloud data 144, the Internet 145, GPS 146, news and finances 147, and/or video 148. The suite of data sources 14 can include public information as well as information obtained from the employee's personal and/or business accounts. By incorporating such a wide breadth of information, the control system 12 can determine details regarding each employee, such as their location, habits, tendencies, viewpoints, focus, interests, experience, responsiveness, intake of the training, and/or expertise. The control system 12 can then incorporate such details regarding the employee into a tailored and custom training program for the employee. Accordingly, the training program can be more relatable for the employee to better capture the employee's attention and focus as well as improve retention of the training program. Also, the training program can also be based on one or more of the suite of data sources 14 such that the training program is tailored to the jobsite.

In at least one example, the training program for the employee can be determined based on the project data. The control system 12 can receive data regarding the project, for example the project progress, the safety of the project, the desired timeline for the project, the tasks needing to be completed, etc. Based on the project data, the control system 12 can tailor the training program for the employee so that the employee is ready to perform the task that is needed at that time and/or improve their performance for tasks at hand for the project.

In some examples, the control system 12 can also be operable to adjust the training program to improve the employee's performance. In some examples, the adjustments can be made in real-time. In some examples, the control system 12 can retain the details for the employee over a period of time and determine trends regarding the employee. The control system 12 can then make adjustments as needed based on the trends. For example, the control system 12 may receive the details regarding the employee from the suite of data sources 14 and determine that the employee needs re-training on a particular subject. For example, the employee may, based on their emails and Internet searches, have not have fully understood part of the training program, as the employee has been trying to obtain more details about that part of the training program. The control system 12 can then determine adjust the training program for the employee to reincorporate that part of the training. In some examples, the control system 12 can adjust the training program to provide that part of the training program in a different manner, for example provide different exemplary scenarios, to help the employee better understand the training. The employee's performance should then improve based on such adjustments. By the control system 12 being able to obtain details regarding the employee and make such determinations regarding the training needed for that particular employee, accidents and/or poor job quality can be proactively reduced and/or prevented.

In some examples, the control system 12 can be operable to receive details from the suite of data sources 14 for a plurality of employees. In some examples, the details for the plurality of employees can be received simultaneously. In some examples, the control system 12 can retain the details over a period of time and determine trends regarding the plurality of employees. The control system 12 can then tailor a custom training program for the plurality of employees and/or a group of the plurality of employees that would need similar training. The control system 12 can also adjust the training program for the plurality of employees in the same way as discussed above for the single employee, to improve the performance of the plurality of employees which in turn can improve the overall performance and result of the jobsite. For example, the employee can have a badge that registered to that employee. The training system 10 can include one or more additional badges 100, each operable to be registered with corresponding one or more additional employees. The additional badges 100 can be operable to transmit credentials of the additional employees and the badge 100 can be operable to transmit credentials of the employee to the training system 10 (e.g., the training stations 101, the training kiosks 106, and/or the VR systems 108). The training program can be customized based on the credentials of the employee and the credentials of the additional employees. The employee and the additional employees can be required to each finish at least a part of the training program before being able to continue with their work on the jobsite.

The badge 100 is operable to be registered with the employee(s). Accordingly, the badge 100 is personalized for each individual that is present on the jobsite and/or is receiving training. While the disclosure focuses on employees, the individual may not be an employee and may be a contractor, a guest, a government agent, etc. without deviating from the scope of the disclosure.

In some examples, the badge 100 can be operable to track attendance of the employee. In some examples, the badge 100 can be operable to track location of the employee. In some examples, the badge 100 can be operable to track safety of the employee on the jobsite. For example, the badge 100 can include at least one of the following sensors: camera, microphone, accelerometer, GPS, and/or other sensors to determine the activities being performed by the employee. In some examples, the badge 100 can provide such information received by the sensors to the control system 12 such that the training program can be adjusted and/or the activities of the employee can be controlled.

The badge 100 can be operable to communicate (e.g., transmit and/or receive data) with the VR systems 108, the training kiosks 106, and/or the training stations 101. The badge 100 can also be operable to communicate with the control system 12 and/or the suite of data sources 14. The badge 100 can be operable to communicate with the VR systems 108, the training kiosks 106, the training stations 101, the control system 12, and/or the suite of data sources 14 through a wireless mechanism. For example, the badge 100 can be operable to communicate via Bluetooth, radio frequency identification (RFID), near field communication (NFC), Wi-Fi, Zigbee, Long Range (LoRa), cellular networks, infrared (IR), thread, wireless personal area networks, etc.

In at least one example, the control system 12 can be operable to provide task information to the badge 100. For example, the task information can include tasks that the employee is approved to perform and is prohibited from performing. By controlling the tasks that the employee can perform, the safety of the employee and the overall jobsite can be improved. In some examples, the badge 100 can be operable to communicate with the control system 12, and the control system 12 can be operable to control the access of the employee throughout the jobsite.

The training program can be offered to the employee(s) in a plurality of ways to engage with the learning material in the training program. Accordingly, the training system 10 can be configured towards individual learning and/or group learning or presentations. For example, as illustrated in FIG. 1, the one or more VR systems 108, the one or more training kiosks 106, and/or the one or more training stations 101 can each be operable to provide the training program to the employee(s). The VR systems 108, the training kiosks 106, and/or the training stations 101 can be operable to provide the training program to the employee(s) in different ways so that the employee can absorb the learning materials in the manner best suited for their learning style. In at least one example, the badge 100 can be operable to transmit credentials of the employee to the VR systems 108, the training kiosks 106, and/or the training stations 101. Accordingly, the training program can be customized based on the credentials of the employee.

As the employee receives the training during the course of the training program, the badge 100 can be operable to receive progress of the employee for the training program from the VR systems 108, the training kiosks 106, and/or the training stations 101. The badge 100, based on the progress of the employee for the training program and/or the retention of the learning materials, can then communicate with different elements on the jobsite to control the employee's access or activities on the jobsite. In some examples, the badge 100 can be operable to receive project data regarding the project for the employee. For example, the badge 100 can receive the project data from the control system 12. The badge 100, based on the progress of the training program received by the employee and the project data, can control the access of the employee throughout the jobsite. In some examples, the badge 100, based on the progress of the training program, is operable to provide access to the VR systems 108, the training kiosks 106, and/or the training stations 101.

In some examples, based on the progress of the employee through the training program, the badge 100 can be operable to unlock a second training program for the employee. For example, the badge 100 may allow for the employee to enter a different area of the jobsite to receive the second training program that correlates with the work for that different area. In some examples, the badge 100 can be utilized to interact with a different one of the VR systems 108, the training kiosks 106, and/or the training stations 101 that is better suited to provide the second training program.

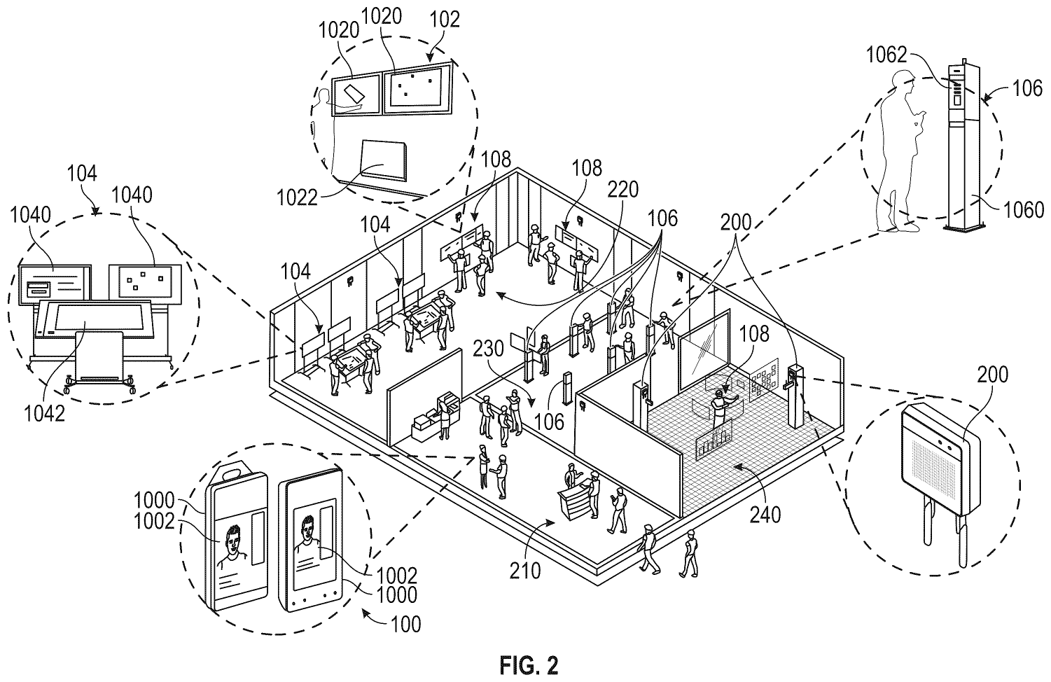

In at least one example, as illustrated in FIG. 2, the training system 10 can include a training environment with a plurality of training rooms 210, 220, 230, 240 that can provide the training program for the employee(s). For example, the VR systems 108 can be disposed in a VR training room 240, the training kiosks 106 can be disposed in a kiosk training room 230, and the training stations 101 can be disposed in a station training room 220. In some examples, as illustrated in FIG. 2, the VR training room 240, the kiosk training room 230, and the station training room 220 can be provided in a same building. In some examples, one or more of the VR training room 240, the kiosk training room 230, and the station training room 220 can be provided in different buildings.

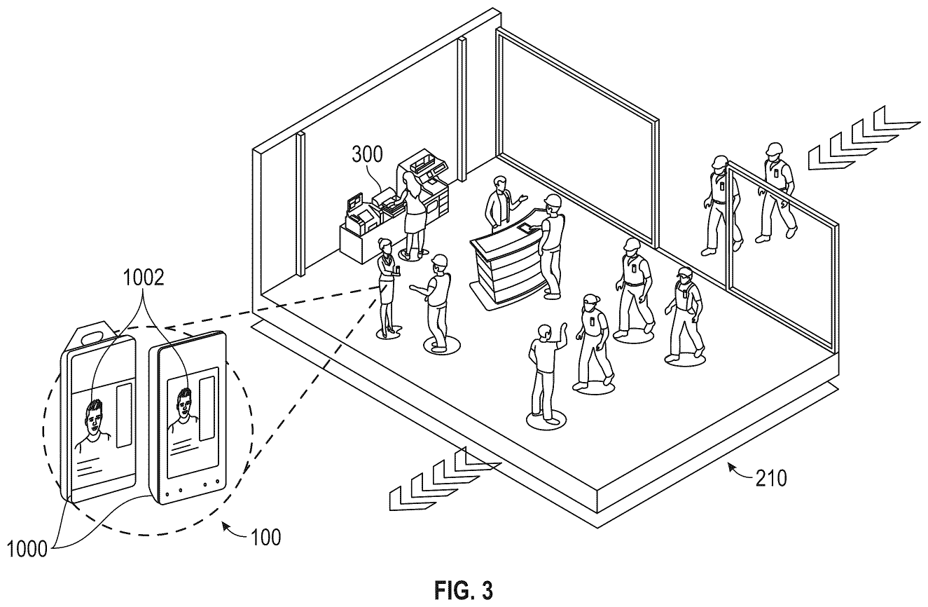

FIG. 3 illustrates a badge room 210, in which the employee(s) can receive their badge 100. The employee can enter the badge room 210 and provide their credentials (e.g., identification information, employee number, job title, phone number, etc.). A badge printer 300 can be utilized to create the badge 100 for that employee. By having the badge printer 300 on site, the badges 100 can be created quickly and efficiently to avoid any delays in the employee's access to the jobsite and/or the training system 10. The badge printer 300 can be utilized to register the badge 100 to the employee. In some examples, as illustrated in FIG. 3, the badge 100 can include a body 1000 that can be attached to the employee, for example by a pin, a clip, a lanyard, etc. In some examples, the badge 100 can include a display 1002 on the body 1000. The display 1000 can be include the employee's credentials such that the employee's credentials can be confirmed by visual inspection. In some examples, display 1002 can include a picture and/or the employee's name. In some examples, the display 1002 can include a screen that can be adjusted, for example remotely by the control system 12, to display notifications to the employee or other employees regarding the employee. For example, the notifications may notify that the employee is not allowed access to that area on the jobsite. In some examples, the notifications may notify that the employee is allowed access to that area on the jobsite. In some examples, the notifications may notify that the employee is allowed or prohibited from performing certain activities while on the jobsite. In some examples, the badge 100 is operable to control an alert to inform the employee and/or other employees that the employee is entering the area of the jobsite when access is not approved. For example, the alert can include text or color on the display 1002 of the badge 100. In some examples, the alert can include a sound emitted from the badge 100. In some examples, the alert can include a vibration or movement of the badge 100.

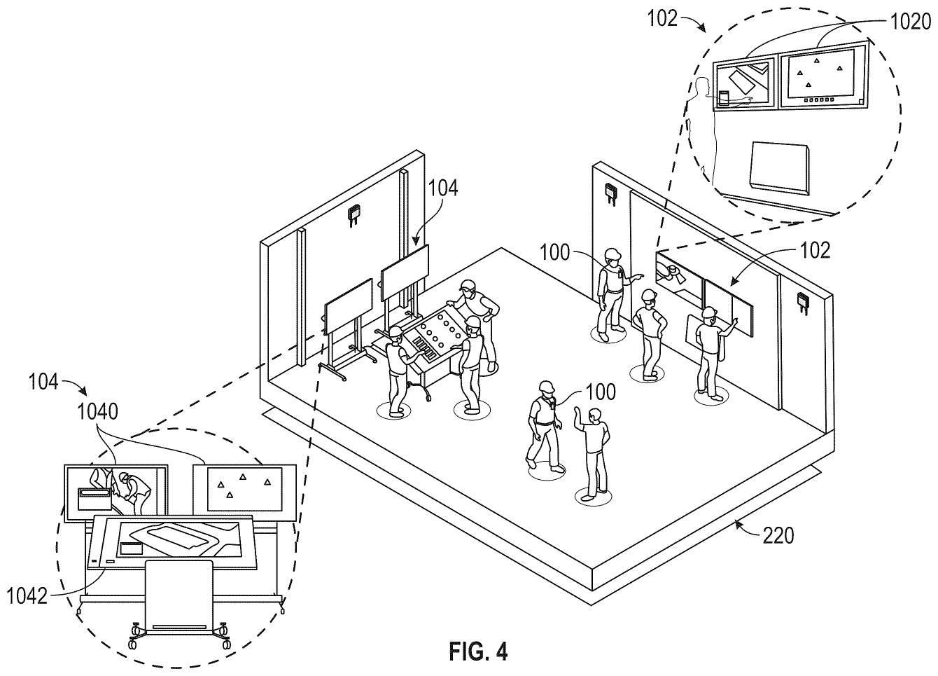

FIG. 4 illustrates the station training room 220. The station training room 220 can provide the training program for the employee via the training stations 101. The training stations 101 can be operable to communicate with the badge(s) 100 for the employee(s) to provide customized training programs. For example, the training station 101 can determine which employee(s) are within a predetermined range to interact with the training station 101 so that the training station 101 can provide the training program. When there are multiple employees within the predetermined range, the control system 12 may provide, via the training station 101, an adjusted training program to accommodate the employees. In some examples, the control system 12 may determine that some of the employees, based on their badges 100, should not be receiving the training program. The training station 101 may then indicate to the employees that they should go to another training station 101. In some examples, the training station 101 may include a badge sensor where a badge 100 can be brought within a predetermined distance to check in (e.g., badge in) the employee at that training station 101. The control system 12 can then adjust the training program being provided by that training station 101 to correspond with that employee.

The training stations 101 can include any combination of a smart table 1042 and/or a plurality of display screens 1020, 1040. For example, the training stations 101 can include a wall station 102 that includes one or more display screens 1020. The display screens 1020 can be interactive, for example touch, gesture, and/or equipment (e.g., mouse and keyboard) controlled. The display screens 1020 can be coupled with a wall so that one or more employees can gather around the wall station 102 to receive the training program. When the display screens 1020 are coupled with the wall, the wall station 102 can have a space saving footprint. In at least one example, the training stations 101 can include a smart station 104 which can include a smart table 1042 and one or more display screens 1040. The smart table 1042 can be touch controlled, gesture controlled, and/or equipment controlled. In at least one example, the smart table 1042 can provide holographic images to provide a better three-dimensional understanding of the training being provided. The display screens 1040 can be interactive, for example touch, gesture, and/or equipment (e.g., mouse and keyboard) controlled. In some examples, the smart table 1042 and the one or more display screens 1040 can communicate so that the images or interactions with the employee(s) can be seamlessly displayed across both the smart table 1042 and the display screens 1040.

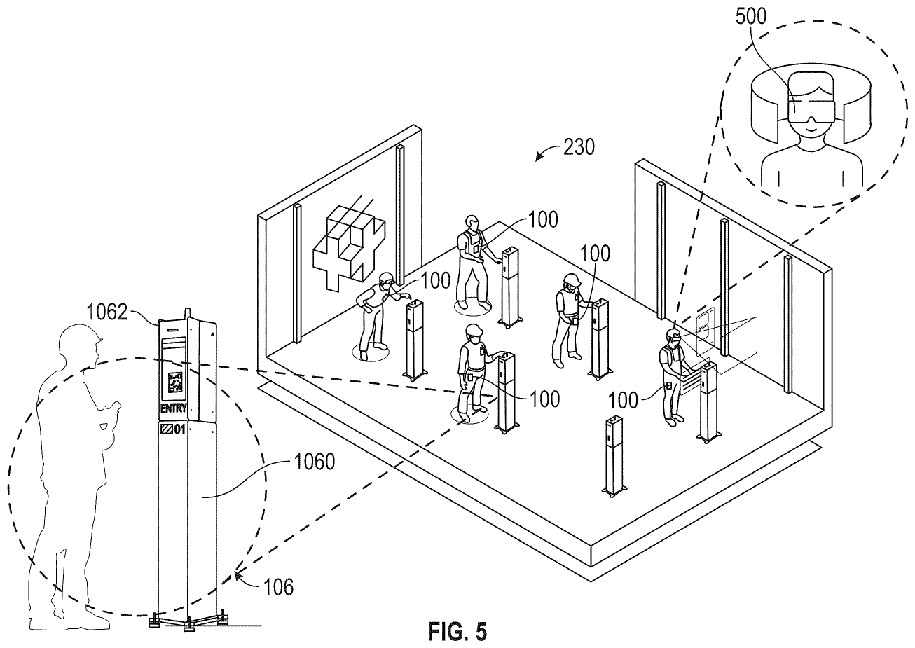

FIG. 5 illustrates the kiosk training room 230. The kiosk training room 230 can be operable to provide one or more training kiosks 106 operable to provide the training program to the employee(s). The training kiosks 106 can be operable to communicate with the badge(s) 100 for the employee(s) to provide customized training programs. For example, the training kiosks 106 can determine which employee(s) are within a predetermined range to interact with the training kiosks 106 so that the training kiosk 106 can provide the training program. When there are multiple employees within the predetermined range, the control system 12 may provide, via the training kiosks 106, an adjusted training program to accommodate the employees. In some examples, the control system 12 may determine that some of the employees, based on their badges 100, should not be receiving the training program. The training kiosks 106 may then indicate to the employees that they should go to another training kiosks 106. In some examples, the training kiosks 106 may include a badge sensor where a badge 100 can be brought within a predetermined distance to check in (e.g., badge in) the employee at that training kiosks 106. The control system 12 can then adjust the training program being provided by that training kiosks 106 to correspond with that employee.

As illustrated in FIG. 5, the training kiosk 106 can include a stand 1060 and/or a display 1062. The display 1040 can be interactive, for example touch, gesture, and/or equipment (e.g., mouse and keyboard) controlled. The display 1062 can be coupled with the stand 1060. In some examples, the training kiosk 106 can be portable and moveable so that the training program can be provided at convenient locations.

In some examples, as illustrated in FIG. 5, one or more of the training kiosks 106 can be operable to provide augmented reality. Augmented reality overlays digital information, such as images or data, onto a real-world environment. By using augmented reality, the employee can experience a blend of computer-generated elements and the physical world through equipment 500, such as smartphones, glasses, or headsets. With augmented reality, the training kiosk 106 can provide enhanced real-time interaction and contextual information. The equipment 500 can be operable to communicate with the training kiosk 106 to provide the relevant details for the customized training program for that employee. For example, the equipment 500 may only display information that correlates with that employee's access and job tasks. Even if another employee looks at the same thing, the other employee may see different displayed information through their equipment 500 than the first employee.

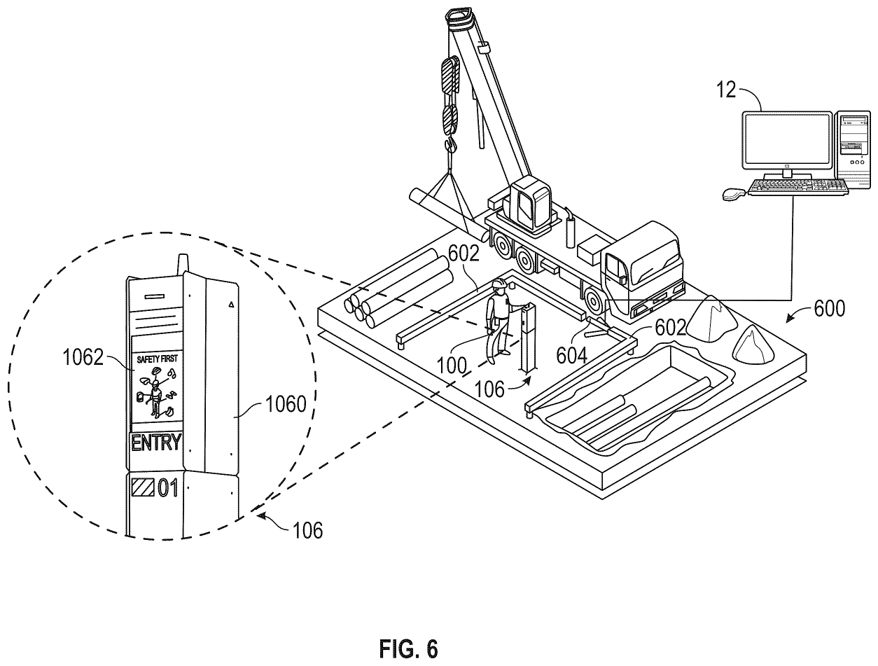

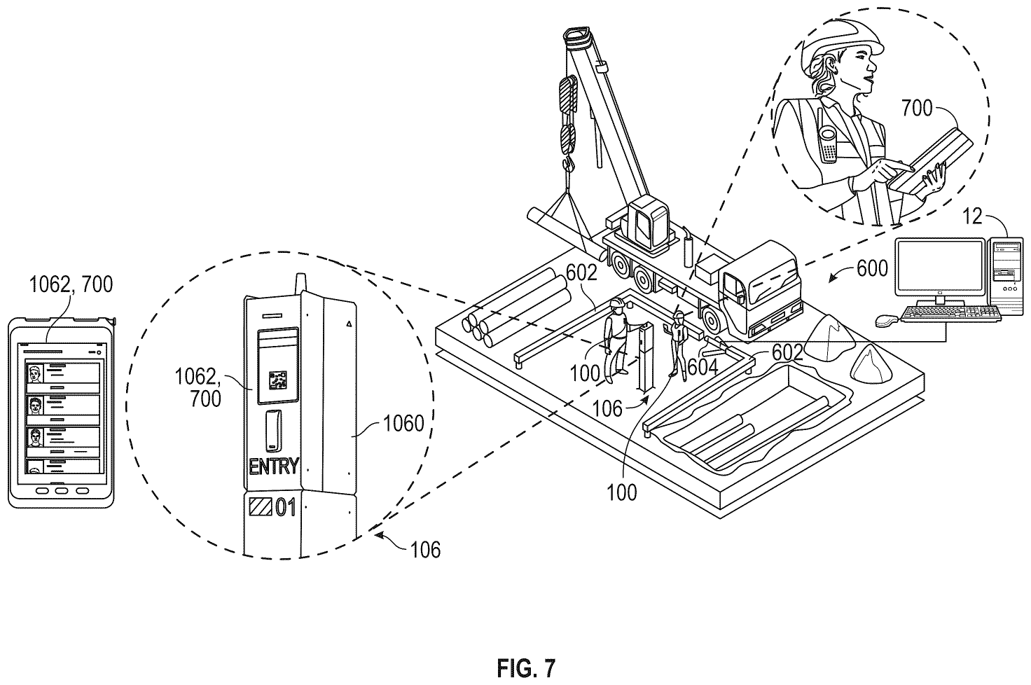

In some examples, as illustrated in FIGS. 6 and 7, the training kiosks 106 can be provided on the jobsite 600. Accordingly, training can continue and be provided even on the jobsite 600, as the training kiosk 106 can provide on-site and/or on-demand training. This can improve safety and work product, as employees may receive the training they need for each task at hand. In some examples, as illustrated in FIGS. 6 and 7, the workplace training can include training for construction. Construction workplaces can be extremely dangerous, so training is critical to ensure that the jobsite is safe and the work is completed efficiently and effectively. While FIGS. 6 and 7 illustrate a construction workplace, the training can be completed for other workplaces such as oil and gas, refineries, energy sites, mining, wastewater operations, etc.

In some examples, the training kiosks 106 can be operable to provide safety reminders. In some examples, the training kiosks 106 can be operable to communicate real-time hazard warnings. For example, the training kiosks 106 can display (e.g., via the display 1062) text and/or color. In some examples, the training kiosks 106 can emit a sound. In some examples, the training kiosks 106 can include and/or communicate with sensors, such as cameras, that can determine the tasks being performed by each employee on the jobsite 600. The control system 12 can determine whether any of the tasks are being performed correctly and/or are being performed by the correct employee (e.g., based on the training they have completed). In certain circumstances, if the tasks are being performed incorrectly and/or are being performed by the incorrect employee, the training kiosks 106 and/or the badge 100 can then inform the employee that they need more training and/or to stop what they are doing. The employee can then approach the training kiosk 106 to receive the necessary training program.

In some examples, as illustrated in FIG. 7, the display 1062 for the training kiosk 106 can include a tablet 700. In at least one example, the tablet 700 can be detachably coupled with the stand 1060. Accordingly, as illustrated in FIG. 7, the employee can take the tablet 700 for convenient on-the-go training. In some examples, the training program for the employee can be adjusted as the employee moves around with the tablet 700. Accordingly, the tablet 700 can be moved to the area of the jobsite 600 so that the employee can easily correlate the learning materials from the training program on the tablet 700 with that area of the jobsite 600. In some examples, the tablet 700 can include sensors, such as cameras, to capture images, videos, and/or sounds of the jobsite 600. The control system 12 can then receive such data from the tablet 700 and adjust the training program for the employee based on the real-world application from the jobsite 600.

In some examples, the badge 100 can be operable to control access of the employee into an area 602 of the jobsite 600 based on the progress of the employee for the training program. For example, as illustrated in FIGS. 6 and 7, the badge 100 can be operable to communicate with an entry structure 604 for the area 602 of the jobsite 600 such that the entry structure 604 prevents passage of the employee into the area 602. In some examples, the badge 100 can be operable to communicate with the entry structure 604 of the area 602 to permit passage of the employee into the area 602. For example, the entry structure 604 can include a turnstile, security gate, speed gate, revolving door, etc. such that the entry structure 604 can control access to the area 602 of the jobsite 600. In some examples, the entry structure 604 can communicate with the badge 100 wirelessly, for example RFID, Wi-Fi, Bluetooth, NFC, etc. In some examples, the entry structure 604 can automatically permit the employee to walk through into the area 602 of the jobsite 600 as the employee approaches the entry structure 604 within a predetermined distance. In some examples, the employee may need to badge in at the entry structure 604 to receive access to the area 602 of the jobsite 600. By controlling access to the area 602 based on the progress of the training received by the employee (e.g., via the badge 100), the safety and work in that area 602 of the jobsite 600 can be improved.

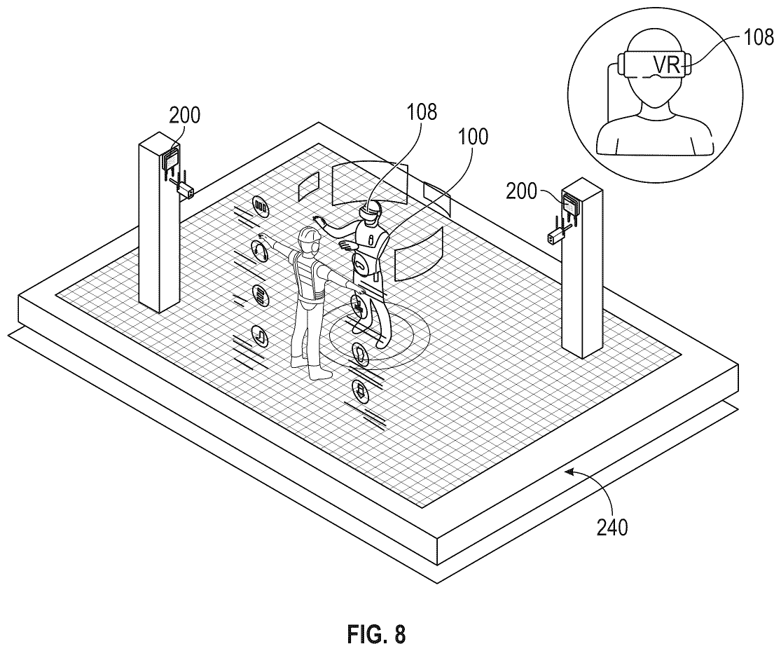

FIG. 8 illustrates the VR training room 240. The VR training room 240 can be operable to provide one or more VR systems 108 operable to provide the training program to the employee(s). The VR systems 108 can provide a computer-generated, immersive environment that simulates a realistic three-dimensional experience in a controlled environment. The VR systems 108 can include headsets that are operable to be worn by the employee(s). The VR systems 108 can transport the employee(s) to a virtual world where they can interact with the environment or objects, experiencing a sense of presence as if they are physically present in that digital space. Accordingly, the employee(s) can receive life-like, interactive training. In some examples, the VR systems 108 can include head-tracking sensors and specialized displays to create the convincing and immersive user experience.

The VR systems 108 can be operable to communicate with the badge(s) 100 for the employee(s) to provide customized training programs. For example, the VR systems 108 can determine which employee(s) are within a predetermined range to interact with the VR systems 108 so that the VR systems 108 can provide the training program. When there are multiple employees within the predetermined range, the control system 12 may provide, via the VR systems 108, an adjusted training program to accommodate the employees. The VR systems 108 may communicate with one another so that the plurality of employees can interact with one another within the virtual reality training program. In some examples, the control system 12 may determine that some of the employees, based on their badges 100, should not be receiving the training program. The VR systems 108 may then indicate to the employees that they should go use another VR system 108 and/or go to another area of the VR training room 240 to give the other employee(s) space to interact with the VR system 108. In some examples, the VR systems 108 may include a badge sensor where a badge 100 can be brought within a predetermined distance to check in (e.g., badge in) the employee at that VR systems 108. The control system 12 can then adjust the training program being provided by that training kiosks 106 to correspond with that employee.

In some examples, the VR systems 108 can be operable to adjust the training based on the employee's performance and needs. For example, in some examples, the employee may have a handicap. The VR system 108 may adjust the training to accommodate that handicap so that the employee can receive accurate life-like training. If the employee is not correctly performing the tasks in the training, the VR system 108 can also adjust the way the training is presented for the employee to better capture the lesson(s) from the training program.

In at least one example, as illustrated in FIG. 8, the training system 10 can include one or more anchors 200 provided throughout the training environment and/or the jobsite. The anchors 200 can be operable to communicate with the VR systems 108, the training kiosks 106, the training stations 101, the badges 100, and/or the control system 12. The anchors 200 can be operable to track the badges 100 and relay information (e.g., activity, movement, training, environment) to the control system 12. The control system 12 can then pass along notifications (e.g., safety warning, inform more training is needed, etc.) to the employee, for example via the badges 100.

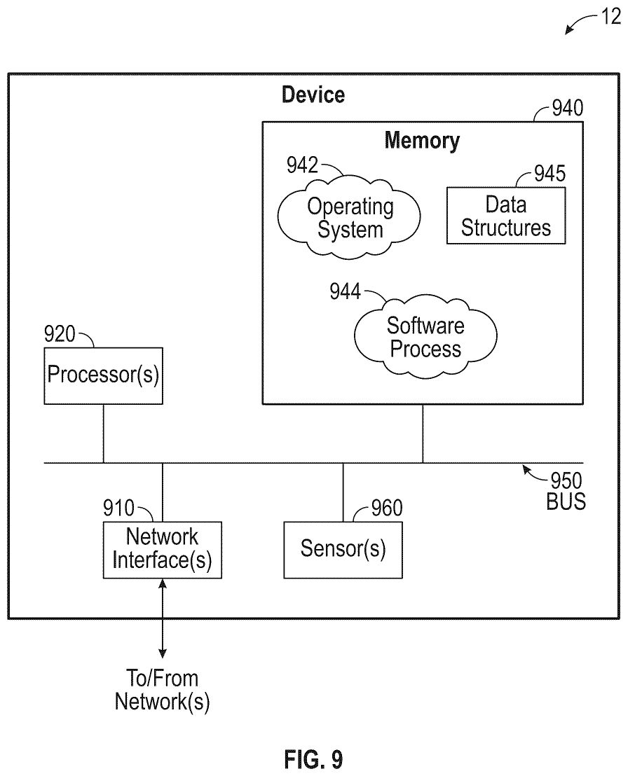

FIG. 9 is a block diagram of an exemplary control system 12. Control system 12 is configured to perform processing of data and communicate with the components, for example as illustrated in FIGS. 1-8. In operation, control system 12 communicates with one or more of the above-discussed components and may also be configured to communication with remote devices/systems.

As shown, control system 12 includes hardware and software components such as network interfaces 910, at least one processor 920, sensors 960 and a memory 940 interconnected by a system bus 950. Network interface(s) 910 can include mechanical, electrical, and signaling circuitry for communicating data over communication links, which may include wired or wireless communication links. Network interfaces 910 are configured to transmit and/or receive data using a variety of different communication protocols, as will be understood by those skilled in the art.

Processor 920 represents a digital signal processor (e.g., a microprocessor, a microcontrol system, or a fixed-logic processor, etc.) configured to execute instructions or logic to perform tasks in a workplace and/or a training environment. Processor 920 may include a general purpose processor, special-purpose processor (where software instructions are incorporated into the processor), a state machine, application specific integrated circuit (ASIC), a programmable gate array (PGA) including a field PGA, an individual component, a distributed group of processors, and the like. Processor 920 typically operates in conjunction with shared or dedicated hardware, including but not limited to, hardware capable of executing software and hardware. For example, processor 920 may include elements or logic adapted to execute software programs and manipulate data structures 945, which may reside in memory 940.

Sensors 960 typically operate in conjunction with processor 920 to perform measurements, and can include special-purpose processors, detectors, transmitters, receivers, and the like. In this fashion, sensors 960 may include hardware/software for generating, transmitting, receiving, detection, logging, and/or sampling varying parameters.

Memory 940 comprises a plurality of storage locations that are addressable by processor 920 for storing software programs and data structures 945 associated with the embodiments described herein. An operating system 942, portions of which may be typically resident in memory 940 and executed by processor 920, functionally organizes the device by, inter alia, invoking operations in support of software processes and/or services 944 executing on control system 12. These software processes and/or services 944 may perform processing of data and communication with control system 12, as described herein. Note that while process/service 944 is shown in centralized memory 940, some examples provide for these processes/services to be operated in a distributed computing network.

It will be apparent to those skilled in the art that other processor and memory types, including various computer-readable media, may be used to store and execute program instructions pertaining to the training techniques described herein. Also, while the description illustrates various processes, it is expressly contemplated that various processes may be embodied as modules having portions of the process/service 944 encoded thereon. In this fashion, the program modules may be encoded in one or more tangible computer readable storage media for execution, such as with fixed logic or programmable logic (e.g., software/computer instructions executed by a processor, and any processor may be a programmable processor, programmable digital logic such as field programmable gate arrays or an ASIC that comprises fixed digital logic. In general, any process logic may be embodied in processor 920 or computer readable medium encoded with instructions for execution by processor 920 that, when executed by the processor, are operable to cause the processor to perform the functions described herein.

Additionally, the control system 12 can apply machine learning, such as a neural network or sequential logistic regression and the like, to determine relationships between the training and the employee. For example, a deep neural network may be trained in advance to capture the complex relationship between the training completed and the work being done by the employee. This neural net can then be deployed in the determination of access for the employee. As such, the determination of whether the employee can be allowed access in certain areas or determine what activity the employee is performing in relation to the type of training completed can be more accurate.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A training system operable to provide workplace safety training, the training system comprising:
one or more training mechanisms; and
a badge operable to be registered with an employee, the badge being operable to communicate with the one or more training mechanisms,
wherein the one or more training mechanisms are each operable to provide a training program to the employee,
wherein the badge is operable to receive progress of the employee for the training program from the one or more training mechanisms,
wherein the badge is operable to control access of the employee into an area of a jobsite based on the progress of the employee for the training program.

2. The training system of claim 1, wherein the one or more training mechanisms include one or more VR systems, one or more training kiosks, and/or one or more training stations.

3. The training system of claim 1, wherein the badge is operable to communicate with an entry structure for the area of the jobsite such that the entry structure prevents passage of the employee into the area.

4. The training system of claim 1, wherein the badge is operable to communicate with a control system that is operable to control the access of the employee throughout the jobsite.

5. The training system of claim 4, wherein the control system is operable to provide task information to the badge, wherein the task information includes tasks that the employee is approved to perform and is prohibited from performing.

6. The training system of claim 1, wherein the badge is operable to unlock a second training program for the employee based on the progress.

7. The training system of claim 1, wherein the badge, based on the progress of the training program, is operable to provide access to the one or more training mechanisms.

8. The training system of claim 1, wherein the training program is based on one or more sources of a suite of data sources such that the training program is tailored to the jobsite.

9. The training system of claim 1, wherein the badge is operable to receive project data regarding a project for the employee.

10. The training system of claim 9, wherein the training program for the employee is determined based on the project data.

11. The training system of claim 1, wherein the badge is operable to track attendance, location, and/or safety of the employee.

12. The training system of claim 1, wherein the badge is operable to transmit credentials of the employee to the one or more training mechanisms.

13. The training system of claim 12, wherein the training program is customized based on the credentials of the employee.

14. The training system of claim 1, further comprising one or more additional badges, each of the one or more additional badges operable to be registered with corresponding one or more additional employees, wherein the one or more additional badges are operable to transmit credentials of the one or more additional employees and the badge is operable to transmit credentials of the employee to the one or more training mechanisms.

15. The training system of claim 14, wherein the training program is customized based on a combination of the credentials of the employee and the credentials of the one or more additional employees.

16. A method comprising:
providing, via one or more training mechanisms, a training program to an employee;
transmitting, to a badge registered with the employee, progress of the employee for the training program; and
controlling access of the employee into an area of a jobsite based on the progress of the employee for the training program.

17. The method of claim 16, further comprising:
unlocking a second training program for the employee based on the progress.

18. The method of claim 16, further comprising:
transmitting, from the badge, credentials of the employee to the one or more training mechanisms, wherein the training program is customized based on the credentials of the employee.

19. The method of claim 16, further comprising:
communicating, by the badge, with a control system that is operable to control the access of the employee throughout the jobsite;
providing, by the control system, task information to the badge, wherein the task information includes tasks that the employee is approved to perform and is prohibited from performing.

20. The method of claim 16, wherein the one or more training mechanisms include one or more VR systems, one or more training kiosks, and/or one or more training stations.
